(19) United States
(12) Patent Application Publication
(10) Pub. No.: US 2024/0233162 A1
(43) Pub. Date: Jul. 11, 2024

(54) Systems and Methods for Construction with Detection, Guidance, and/or Feedback

(71) Applicant: Chain Orthopedics, LLC, Bogota, NJ (US)

(72) Inventors: Timothy J. LANGLOSS, Berwyn, PA (US); Charles LUDDY, Alexandria, VA (US); Paul VIOLA, Bogota, NJ (US)

(73) Assignee: Chain Orthopedics, LLC, Bogota, NJ (US)

(21) Appl. No.: 18/393,784

(22) Filed: Dec. 22, 2023

Related U.S. Application Data
(60) Provisional application No. 63/437,816, filed on Jan. 9, 2023.

(51) Int. Cl. G06T 7/62; G05B 19/04; G06Q 50/08; G06T 17/00; G08B 3/00; G08B 5/00; G08B 6/00

(52) U.S. Cl. CPC G06T 7/62; G05B 19/0405; G06Q 50/08; G06T 17/00; G08B 3/00; G08B 5/00; G08B 6/00; G06T 2207/30184; G06T 2207/30204

(57) ABSTRACT

Systems and methods for construction with detection, guidance, and/or feedback are disclosed. A system may include one or more of the following subsystems: (1) a detection subsystem, (2) a computer subsystem, (3) a translation subsystem, (4) a control subsystem, and/or (5) a user feedback subsystem. The detection subsystem may comprise one or more cameras, scanners, or sensors for detecting information associated with a space, one or more workpieces, or one or more tools. The computer subsystem may be adapted to receive data from the detection subsystem and to use the data received from the detection subsystem to make calculations for a desired construction project.

### CROSS-REFERENCE TO RELATED APPLICATIONS

This application claims priority to U.S. Provisional Patent Application No. 63/437,816, filed Jan. 9, 2023, entitled “Systems and Methods for Construction with Detection, Guidance, and/or Feedback,” the entire contents of which are incorporated herein by reference.

This application is related also to U.S. patent application Ser. No. 17/443,646, filed Jul. 27, 2021, entitled “Chain Saws, Components for Chain Saws, and Systems for Operating Chain Saws,” U.S. patent application Ser. No. 17/590,192, filed Feb. 1, 2022, entitled “Cutting Guide Systems and Methods,” U.S. patent application Ser. No. 17/741,734, filed May 11, 2022, entitled “Devices for Maintaining Tension in Chain Saws,” U.S. patent application Ser. No. 18/102,910, filed Jan. 30, 2023, entitled “Knives and Other Tools and Devices Incorporating Cutting Chains,” and U.S. patent application Ser. No. 18/315,003, filed May 10, 2023, entitled “Controls, Feedback, Cutting Variations, and Accessories for Chain Saws.” The entire contents of these applications are incorporated herein by reference.

### TECHNICAL FIELD

The present disclosure is directed to systems and methods for construction using detection, guidance, and/or feedback.

### BACKGROUND

In the field of construction, many tasks can be tedious, time-consuming, dangerous, or susceptible to errors. For example, cutting and framing structures can require steps of measuring, cutting wood or other components, checking the fit, measuring again, and finally fixing the wood or other components in the right positions. This measuring and cutting process can require workers to climb up and down ladders with heavy materials and/or tools again and again, often for the same board or other component that needs to be placed. Various other construction tasks require steps with similar disadvantages.

### SUMMARY

In some embodiments, systems as disclosed herein include one or more of the following subsystems: (1) a detection subsystem, (2) a computer subsystem, (3) a translation subsystem, (4) a control subsystem, and/or (5) a user feedback subsystem. In some embodiments, any of these subsystems may be used without the other subsystems. In some embodiments, any two or more of these subsystems may be used together without the other subsystems.

### BRIEF DESCRIPTION OF THE DRAWINGS

FIG. 1 illustrates an example embodiment of a system for construction in accordance with the disclosure.

### DETAILED DESCRIPTION

In some embodiments, a detection subsystem includes one or more devices for detecting information associated with a construction space, one or more workpieces within or for a construction space, or one or more tools. For example, a detection subsystem may include one or more cameras, optionally with one or more markers that may be placed at locations on or in the construction space, or on or in one or more workpieces or tools. As another example, a detection subsystem may include one or more scanners, such as a laser scanner. As another example, a detection subsystem may include one or more ultrasound or echolocation detectors. As another example, a detection subsystem may include one or more RFID readers, in conjunction with one or more RFID tags that may be placed at locations on or in the construction space, or on or in one or more workpieces or tools. In some embodiments, the detection subsystem may include one or more sensors or connections (e.g., wired or wireless connections) for providing information regarding the tool. Such information may include, for example, information regarding the location, orientation, operating mode, RPM, torque, heat, wear, or other condition of a tool or a component thereof.

In use, the detection subsystem may acquire data from the construction space or from one or more workpieces or tools. For example, the detection subsystem (e.g., camera, scanner, etc.) may be used to image or scan an entire construction space, or a portion thereof, for obtaining dimensional and/or spatial information. In a further example, such information may be used by a computing subsystem for constructing a 3D model of the space. As another example, the detection subsystem (e.g., camera, scanner, etc.) may be used to locate points for acquiring locations and distances. In another example, the detection subsystem may acquire data regarding the tool or a component thereof (e.g., location, orientation, operating mode, RPM, torque, heat, wear, or other condition), which may be used by a control subsystem for controlling the tool and/or providing feedback to a user (through a user feedback subsystem).

In some embodiments, a computer subsystem may take data from a detection subsystem, from user input, or from both. The computer subsystem may include a computer (including, e.g., a processor) running programming (software, hardware, and/or firmware).

In use, the computer subsystem may use the supplied data to make calculations for a desired construction project. For example, a computer subsystem may use the data to map a construction space and/or one or more workpieces and compute desired information, such as how many workpieces (boards, sheets of drywall, PVC piping, electrical or other components, etc.) to use, the dimensions to which they should be supplied or cut, and/or how they should be manipulated and/or assembled. Additionally or alternatively, the computer subsystem may compute where to cut, drill, fasten, etc., in or on the construction space and/or workpieces. In just one of many examples, the computer subsystem can compute positions for electrical outlets and other components for compliance with applicable building codes.

In some embodiments, a translation subsystem may be used to mark a construction space or one or more workpieces. The translation subsystem may comprise, for example, a laser or light projector, marker, or engraver.

In use, the translation subsystem (e.g., laser or light projector), based on data or instructions from the computer subsystem, may project light onto a construction space at desired locations. The locations may indicate, for example, places to be cut or not cut, places for components, places for fastening, and the like. In one example, the projection of data could react with a priming on the site, such as a paint that changes color when exposed to a specific wavelength of light, to provide a lasting marking for the construction project.

In some embodiments, a control subsystem comprises components and electronics for controlling and/or manipulating one or more workpieces or tools. The control subsystem may include a computer (including, e.g., a processor) running programming (software, hardware, and/or firmware). The control subsystem may have connections to a tool and/or workpiece that are mechanical (e.g., actuators) and/or electrical (e.g., wired or wireless connections).

In use, the control subsystem may control a tool or workpieces to carry out determined instructions. For example, the control subsystem may actuate a tool, such as a chain saw, to cut areas within the construction space and/or workpieces at indicated locations. As another example, the control subsystem may control automated cutting, drilling, placement, and/or assembling within the construction process. The control subsystem can control accurate cuts (e.g., planar cuts, level cuts, etc.) through the desired material (board, post, sheet, PVC, etc.). As another example, using feedback from a space, workpiece, or tool as described above, the control subsystem may shut down or slow down the tool (e.g., chain saw) when approaching a dangerous condition (e.g., nearing a location unintended to be cut), or otherwise control the tool using feedback (e.g., moving directions based upon real-time location feedback).

In some embodiments, the user feedback subsystem comprises one or more devices for providing visual, tactile, and/or auditory feedback to a user, such as a user of a tool. For example, the user feedback subsystem may comprise one or more lights, speakers, or vibration devices.

In use, the user feedback subsystem may activate to alert the user of a tool to a certain condition. For example, the user feedback subsystem may provide light, sound, vibration, or other feedback to indicate a certain condition. Examples of such conditions may include, for example, getting outside of desired cut lines, approaching an edge, overheating, or other conditions, such as dangerous conditions.

### DESCRIPTION OF THE ILLUSTRATED EXAMPLE

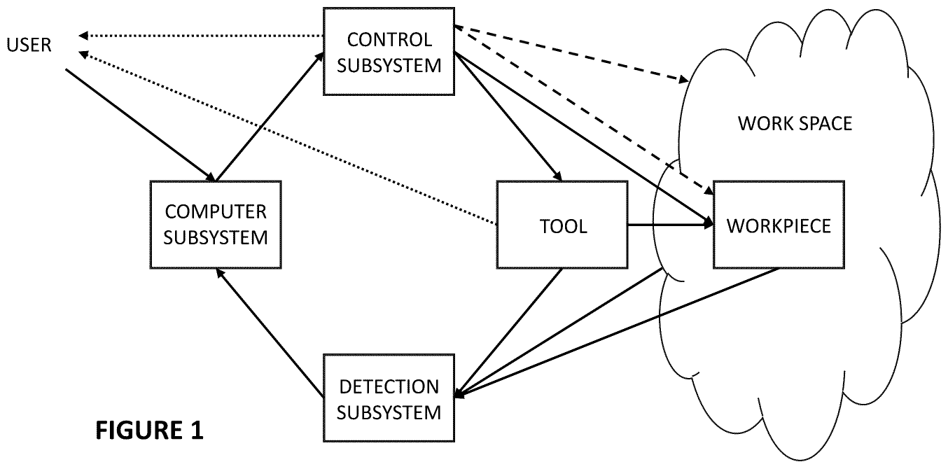

As shown in FIG. 1, certain embodiments as disclosed herein may be directed to a system with the following example subsystems: (1) a detection subsystem, (2) a computer subsystem, and (3) a control subsystem. The system may also include a translation subsystem (indicated in FIG. 1 by dashed lines), and/or a user feedback subsystem (indicated in FIG. 1 by dotted lines).

Information for a project is received into the computer subsystem from a user and/or from a detection subsystem. Information received by the detection subsystem may be received prior to the work (e.g., in a planning or pre-construction phase) or during the work (e.g., in real time). Information received from the detection subsystem may include but is not limited to detailed dimensional and spatial information of the workpiece or space under construction. This may be a 3D scan or other digital representation of the workpiece or space. The detection subsystem may include keys or markers that are placed in the space, on the workpiece, and/or on the tool. Information received from the user instructions may include but is not limited to shapes, patterns, limits, and/or depths.

The computer subsystem takes information received from the detection subsystem and/or external user input to compute instructions for work to be performed and to inform the control subsystem. With instructions from the computer subsystem, the control subsystem controls or manipulates the tool and/or workpiece. During use of the system, the detection subsystem in real-time may detect the position, orientation, and/or conditions of the tool, workpiece, or work space. The computer subsystem uses the spatial and tool information from the detection subsystem to inform the work being completed. The computer subsystem receives information from the detection subsystem, processes the information, and sends instructions to the control subsystem to position, orient, and/or control the tool and/or workpiece. Work being completed by the tool may include but is not limited to cuts, drills, and component placement.

The computer subsystem may also provide information for the translation subsystem (dashed lines in FIG. 1) that then gets combined with the workpiece or space under construction. This may include but is not limited to laser visualization, engraving, or projection. Information provided by the translation subsystem may include but is not limited to shapes, patterns, limits, and/or depths projected or placed onto the workpiece or space.

The system may include a user feedback subsystem (dotted lines in FIG. 1) having one or more devices for providing visual, tactile, and/or auditory feedback to a user. For example, the user feedback subsystem may comprise one or more lights, speakers (such as an alarm), or vibration devices.

The complete system may be used, for example, for determining the dimensions of components for a project, such as boards or other components. For example, the system may use information from the various subsystems to determine where cuts should be made for various components, such as wood or other pieces. The complete system may also be used for automated control and guidance of the tool (e.g., chain saw, drill, etc.) and/or workpiece.

Other systems may involve fewer than all of the subsystems illustrated in FIG. 1. For example, a detection subsystem may be used to collect information on a work space. That information may be received by a computer subsystem that calculates work to be done. Then, a user may use information output from the computer subsystem to manually operate one or more tools to perform the work.

### Imaging and Computer Mapping Examples

In the field of medicine, planning and navigation systems are used to map the anatomy and line up cuts precisely. They typically use imaging targets such as orbs that are affixed to alignment guides and/or tools and an imaging system, typically one or more cameras, that can identify the imaging targets to map the anatomy and cut lines in three dimensions. Software is used to display and adjust the intended cuts. With reference to the system of FIG. 1, this is an example of the detection and computer subsystems working together.

In accordance with some example embodiments herein, an imaging and target system similar to that used in medicine is used in the field of construction. In one embodiment, a builder or other user places one or more imaging targets such as orbs on various points of a construction site, such as on a frame for a roof. Then, the user uses an imaging device such as a camera (i.e., of a detection subsystem) to obtain one or more images of the imaging target(s). The system includes a computer subsystem comprising a computer (including, e.g., a processor) running programming (software, hardware, and/or firmware) that, from the image(s), maps a construction area, such as a frame, in three dimensions. The computer program (e.g., software, etc.) then calculates components required for the project. For example, the computer subsystem determines the number of boards or other components required to complete the frame (e.g., roof) and the precise cuts required for the boards or other components to fit in place as desired for the project.

The system provides information on the cuts to be made for specific pieces, which allows cuts to be completed on the ground or even remotely from the construction site. The framers' job then becomes reduced to assembling the puzzle of the pre-cut materials and affixing them together to form the completed construction project.

In one embodiment a 3D scanner scans the internals of a building prior to drywall being installed. In post processing the data is parsed to identify the various internal components such as piping, electrical components, and HVAC components. The parsed data along with additional information, such as cuts and holes, is then uploaded to a data projection system, such as a laser, that then projects the data onto the site walls. The projection system could be central to a room, allowing for wholistic room visualization and site modifications, or mounted to a tool, allowing for local visualization. The system could work in conjunction with markers and tags placed in the space to provide guided modification to the tool in use.

In conjunction with the previous embodiment, the projection of data could react with a priming on the site, such as a paint that changes color when exposed to a specific wavelength of light. This would allow for the marked data at the site to remain after the light projection is removed, providing extended site data and modification visualization without the need for hardware to remain.

### Subsystem Variations

Variations of the above-described systems and subsystems are possible. For example, a preconstruction detection subsystem may be used for acquiring site data in a planning or pre-construction phase. A preconstruction computer subsystem may be used for processing such pre-acquired site data and computing work to be done. A marker subsystem (e.g., translation subsystem) may be used for marking a work space and/or workpiece prior to or during work.

An in-process real-time acquisition subsystem (e.g., detection subsystem) may be used for real-time feedback of the work being done and of the tool and its position, orientation, and/or condition(s). An in-process real-time control subsystem may be used to continuously adjust the tool and/or workpiece(s) based on feedback from the detection subsystem.

Persons of ordinary skill in the art will appreciate that the embodiments encompassed by the disclosure are not limited to the particular example embodiments described above. While example embodiments have been described, a wide range of modification, change, and substitution is contemplated in the foregoing disclosure. It is understood that such variations may be made to the foregoing without departing from the scope of the disclosure.

What is claimed is:

1. A method of calculating dimensions for construction components using imaging and computerized mapping comprising:
placing an imaging target on a construction site at a first location;
placing an imaging device at a second location;
using the imaging device to capture at least one image of the imaging target; and
calculating dimensions for construction components for the construction site using the at least one image of the imaging target.

2. The method of claim 1, wherein the first location is on a frame for a building.

3. The method of claim 1, wherein the imaging device is a camera.

4. The method of claim 1, comprising placing a plurality of imaging targets at a plurality of locations on the construction site.

5. A system for calculating dimensions for construction components according to the method of claim 1, comprising:
at least one imaging target for placing on a construction site at a first location;
at least one imaging device for capturing at least one image of the imaging target; and
a computer subsystem adapted to calculate dimensions for construction components for the construction site using the at least one image of the imaging target.

6. A system where projected data on a work site remains after a projection is removed comprising of:
at least one projection device; and
at least one reaction material that reacts to a projection from the projection device.

7. The system of claim 6, wherein the reaction material is a paint or other secondary material that is applied to the work site and reacts to specific wavelengths of light or energy.

8. A system for construction comprising:
a detection subsystem; and
a computer subsystem.

9. The system of claim 8, wherein the detection subsystem comprises one or more cameras, scanners, or sensors for detecting information associated with a space, one or more workpieces, or one or more tools.

10. The system of claim 9, wherein the detection subsystem comprises one or more markers adapted to be placed at locations on or in the space, or on or in one or more workpieces or tools.

11. The system of claim 8, wherein the computer subsystem receives data from the detection subsystem and uses the data received from the detection subsystem to make calculations for a desired construction project.

12. The system of claim 8, further comprising a control subsystem, wherein the control subsystem is adapted to provide signals for positioning, orienting, and/or controlling one or more workpieces or tools.

13. The system of claim 8, further comprising a translation subsystem adapted to mark a construction space or one or more workpieces.

14. The system of claim 13, wherein the translation subsystem comprises a laser or light projector, marker, or engraver.

15. The system of claim 8, further comprising a feedback subsystem adapted to provide visual, tactile, and/or auditory feedback.
